(19) United States
(12) Patent Application Publication
(10) Pub. No.: US 2016/0077709 A1
(43) Pub. Date: Mar. 17, 2016

(54) ACTIONABLE ITEM SWITCHER

(71) Applicant: MICROSOFT CORPORATION, Redmond, WA (US)

(72) Inventors: Christopher Doan, Seattle, WA (US); Richard Zarick, Seattle, WA (US); Jeremy Monroe Bowen, Renton, WA (US); Richard Fang, Bellevue, WA (US); Lavanya Vasudevan, Sammamish, WA (US); Chaitanya Dev Sareen, Seattle, WA (US)

(21) Appl. No.: 14/484,717

(22) Filed: Sep. 12, 2014

(51) Int. Cl. G06F 3/0484; G06F 3/0482

(52) U.S. Cl. CPC G06F 3/04842; G06F 3/0482

(57) ABSTRACT

Computer-readable media, computerized methods, and computer systems for initiating actions via a switcher view are provided. In embodiments, a control to present in association with a window representation is determined In a switcher view including a variety of window representations, the control is presented in association with the window representation. Upon a user-selection of the control, an action corresponding with the control is initiated while the switcher view is maintained. Such an action can perform functionality in association with the application.

### BACKGROUND

Operating systems provide a variety of utilities that assist in opening display areas presented at a display component (e.g., computer monitor, screen on a mobile device, and the like). Many operating systems provide a switcher or switcher view to facilitate switching or transitioning from one window to another window. In particular, a switcher presents representations of various windows (e.g., active windows) such that a user can simultaneously view multiple windows and easily select a window to which to switch.

Switching from one window to another window, however, can cause a substantial context shift with respect to tasks being performed on a computing device. For example, assume that a user accessing an application via one window wishes to access another application to modify the volume or other configuration associated therewith. In such a case, the user may activate a switcher view, select the window representation associated with the application the user wishes to access, perform an action associated with the window (e.g., modify the volume), and then return to the initial window to continue using the original application. Such a multi-step operation may be inefficient and decrease user satisfaction, particularly when the user desires to quickly perform an action with respect to the switched to or target window.

### SUMMARY

Embodiments of the present invention are directed to facilitating actions initiated from a switcher view. In this regard, actions can be performed in association with applications represented in a switcher view without requiring the user to visually transition to the actual window to effectuate such an action. In various implementations, controls overlay representations of windows within a switcher view so that a user can initiate a desired corresponding action via the switcher view. A specific control or set of controls to overlay or integrate with a window representation associated with an application can be specified, for example, via an operating system, an application, or a developer thereof. As described herein, additional or alternative actions can also be performed via a switcher view, such as, for instance, filtering window representations, applying actions associated with multiple windows via a single user interaction, or the like.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments;

FIG. 2 is a schematic diagram of an exemplary system architecture suitable for use in implementing embodiments;

FIG. 3 is a schematic diagram of an exemplary switcher manager;

FIG. 4 is an exemplary graphical user interface of an item switcher;

FIG. 5 is an exemplary graphical user interface illustrating various item representations presented in association with controls;

FIG. 6 is an exemplary graphical user interface illustrating a filtered item switcher;

FIG. 7 is an exemplary graphical user interface illustrating various controls overlaying item representations;

FIG. 8 is a flow diagram showing an exemplary method for initiating an action via an item switcher; and

FIG. 9 is a flow diagram showing another exemplary method for initiating an action via an item switcher.

### DETAILED DESCRIPTION

The subject matter is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Generally, embodiments of the invention are directed to providing an actionable item switcher. That is, aspects described herein facilitate initiating actions from an item switcher or switcher view. An item switcher or switcher view refers to a GUI, view, or portion of a display that facilitates switching or transitioning between items. To this end, a switcher view generally includes one or more item representations. By providing multiple item representations, such as active windows, a user can simultaneously view multiple potential items to which to switch and/or perform an action and thereby efficiently select the particular item of interest.

An item, as used herein, refers to any item with which a user can interact and initiate application of an action associated therewith. An item is generally discussed herein as being a window, but is not intended to be limited thereto. Other examples of items include, by way of example and not limitation, applications, files, folders, or the like. A representation of an item, or item representation, refers to any representation used to indicate an item. An item representation can be presented in any form including, but not limited to, icons, thumbnails, identifiers, a text string/label, or the like. As can be appreciated, an item representation, such as a thumbnail, can be static or dynamic in nature (e.g., conform to a current or recent state of the item).

Utilizing item representations presented within a switcher view, actions can be performed in association with items represented in a switcher view without requiring the user to transition to the actual item via the user interface to effectuate such an action. As such, when viewing an item switcher, a user can directly initiate an action to be performed in association with an item as opposed to selecting an item representation and, upon navigating to the item based on the user selection, initiating the action. That is, the window associated with an action does not need to be transitioned or brought to the foreground to implement such an action. To do so, a control can be provided as an overlay to or integrated with an item representation such that actions related thereto can be initiated and performed from a switcher view.

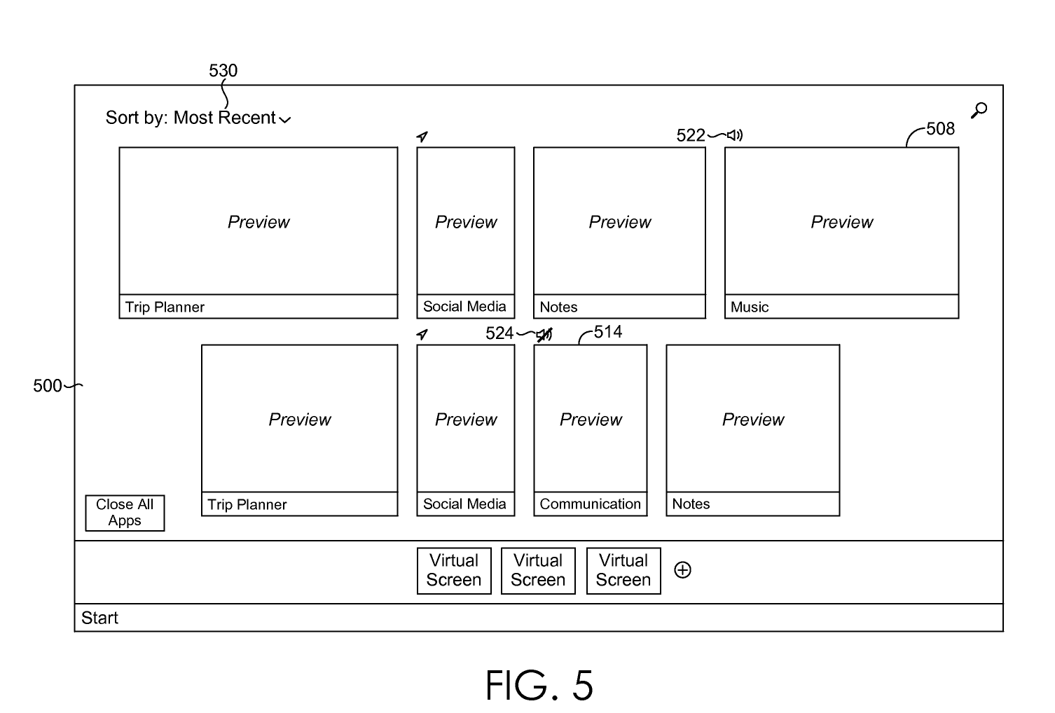

By way of example only, and with reference to FIG. 5, FIG. 5 illustrates an exemplary switcher view 500 having various item representations. As shown in FIG. 5, each of the item representations represent a window (e.g., active window). In a conventional system, to mute audio associated with an application represented by item representation 508, the user would select the item representation 508 and, upon transitioning to the window associated with the application, the user could then navigate via the window to mute the audio. In accordance with embodiments described herein, the user can select the audio control 522 associated with the item representation 508 directly from the switcher view 500 to control the volume.

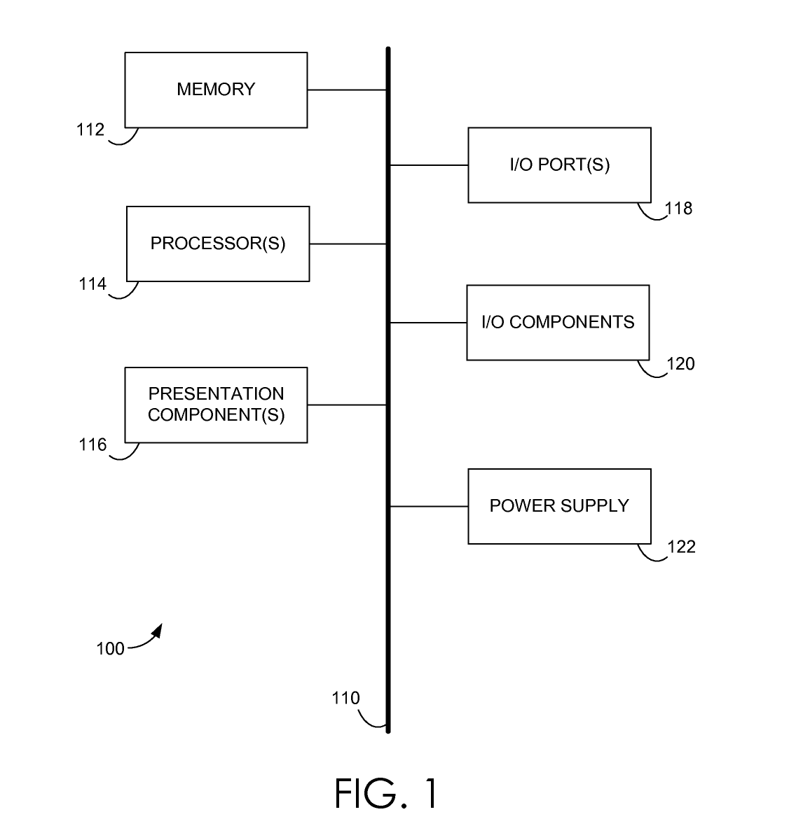

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Computer storage media does not comprise signals per se. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. In embodiments, a microphone or other source of audio stream data is included as an I/O component to provide the audio signals necessary for emotion recognition. Other illustrative I/O components include a joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search requests, words or symbols appearing in apps available for retrieval in response to input search requests, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

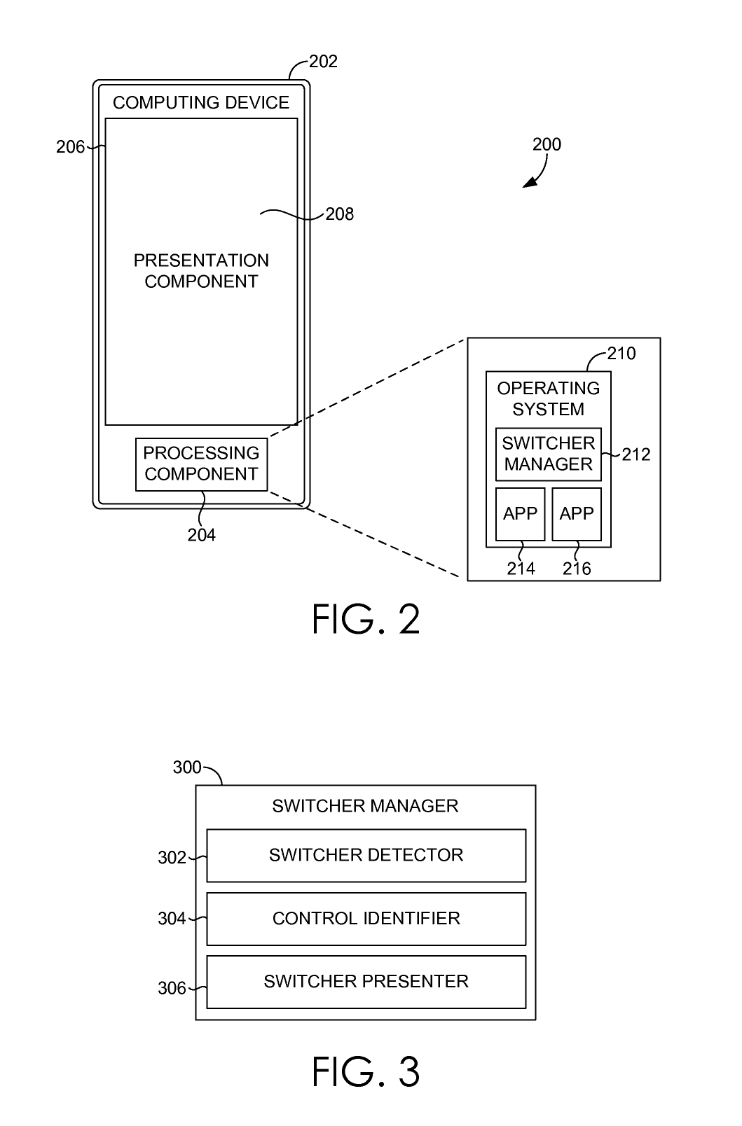

Turning now to FIG. 2, a schematic diagram of exemplary system architecture 200 suitable for use in implementing embodiments of the present invention is shown. It will be understood and appreciated by those of ordinary skill in the art that the exemplary system architecture 200 shown in FIG. 2 is merely an example of one suitable computing environment and is not intended to suggest any limitation as to the scope of use or functionality of the present invention. Neither should the exemplary system architecture 200 be interpreted as having any dependency or requirement related to any single component or combination of components illustrated therein.

Exemplary system architecture 200 includes the computing device 202 for, in part, supporting operation of the processing component 204. In an embodiment where the computing device 202 is a mobile device for instance, a presentation component 206 (e.g., a touchscreen display) may be disposed on the computing device 202. The computing device 202 may take the form of various types of computing devices. By way of example only, the computing device 202 may be a personal computing device (e.g., computing device 100 of FIG. 1), handheld device (e.g., personal digital assistant), a mobile device (e.g., laptop computer, cell phone, media player), consumer electronic device, various servers, and the like. Additionally, the computing device may comprise two or more electronic devices configured to share information therebetween.

In embodiments, as discussed above, the computing device 202 includes the presentation component 206, an input component 208, and the processing component 204 (e.g., hardware) with an operating system 210 installed thereon. The computing device 202 is configured to present a GUI display, such as a switcher view, on the presentation component 206. The presentation component, which may be operably coupled to the processing component 204, may be configured as any display device that is capable of presenting information to a user, such as a monitor, electronic display panel, touch-screen, liquid crystal display (LCD), plasma screen, one or more light-emitting diodes (LED), incandescent bulbs, a laser, an electroluminescent light source, a chemical light, a flexible light wire, and/or fluorescent light, or any other display type, or may comprise a reflective surface upon which the visual information is projected. In one exemplary embodiment, the GUI display rendered by the presentation component is configured to present a switcher view (not shown) having multiple item representations at least a portion of which are integrated or associated with a control to invoke an action with the corresponding item.

The input component 208 is provided to accept user-initiated input(s) affecting, among other things, invoking a switcher view and/or an action in association with a corresponding item. In an exemplary embodiment, the input component 208 receives the user-initiated inputs directed at one or more controls rendered on the GUI. Illustrative devices include a touchscreen display, the I/O components 120 of FIG. 1, or any other component capable of receiving the user-initiated input. By way of example only, the input component 208 may determine a coordinate location of where the user-initiated input initiates contact therewith (e.g., location of actuation) with reference to items rendered at the GUI. As another example, a point(s) selected via a mouse or other selecting device can be detected and used in accordance herewith to invoke a switcher view and/or action in association therewith. As another example, an air gesture can be detected and used in accordance herewith to invoke a switcher view and/or action associated therewith. Although several differing configurations of the input component 208 have been described above, it should be understood and appreciated by those of ordinary skill in the art that various types of input components that receive inputs from physical contact, input devices, or otherwise may be employed as the input component 208.

The operating system (OS) 210 refers generally to the software that manages the sharing of the resources of the processing component and provides programmers with an interface used to access those resources. In operation, the operating system 210 interprets system data and detects the user-initiated inputs (e.g., via the input component 208), and responds by executing various processes, as described herein.

Utilizing heuristics/rules available to the processing component 204, the operating system 210 may perform a variety of logical determinations to identify, among other things, which control should be presented and/or which action should be taken based on the user-initiated input. For instance, a particular control to present in association with an item representation may be determined based on attributes associated with the item. In further embodiments, the operating system is configured to render a control in association with an item representation (e.g., overlay the item representation or integrate with the item representation).

In an exemplary embodiment, the operating system 210 runs on the processing component 204 and supports execution of a switcher manager 212 and one or more of applications, such as application 214 and application 216. In other embodiments, the operating system 210 and/or the applications 214 and 216 may partially or fully reside on a remotely located computing device (e.g., on another operating system, on a server located via a web address, etc.). Generally, applications 214 and 216 are any program that may be launched and manipulated, for instance, by the operating system 210, or portion thereof. Such applications can manage content published on the GUI. Though illustrated as two applications, any number of applications may function to operate via the operating system 210. Such applications may be interrelated to one another or independent of one another.

The switcher manager 212 can provide representations of items within a switcher view, such as application 214 and application 216 or windows associated therewith. Further, and as described in more detail with reference to FIG. 3, the switcher manager 212 can function to enable actions to be performed in connection with a switcher view. For example, the switcher manager can facilitate presentation of controls in association with item representations within the switcher view. Various implementations may be employed to enable actions in connection with item representations within the switcher view. Although the switcher manager 212 is illustrated as operating by way of the operating system 210 and separate from the applications, this operating-system structure is but one example of a suitable structure, and is not intended to suggest any limitation as to the scope of use or functionality of the invention. For example, aspects of the functionality associated with the switcher manager may be performed or governed by an application(s).

Logic within the operating system 210 and/or applications 214 and 216 supporting the exemplary system architecture 200 may be embodied on an internal processing component 204 to a computing device 202, provided from a distributed computing environment, such as a remote server (not shown), or any combination thereof. In embodiments of the invention that are practiced in distributed computing environments, logic communication is linked through appropriate connections. These connections may be wired or wireless. Examples of particular wired embodiments, within the scope of the present invention, include USB connections and cable connections. Examples of particular wireless embodiments, within the scope of the present invention, include a near-range wireless network and radio-frequency technology.

Any number of components may be employed to achieve the desired functionality within the scope of embodiments of the present invention. Although the various components of FIG. 2 are shown with lines for the sake of clarity, in reality, delineating various components/elements is not so clear, and metaphorically, the lines would more accurately be grey or fuzzy. Further, although some components and devices of FIG. 2 are depicted as single blocks, the depictions are exemplary in nature and in number and are not to be construed as limiting.

Turning now to FIG. 3, FIG. 3 illustrates a switching manager 300 in which embodiments of the present invention may be employed. Generally, the switching manager 300 illustrates an environment in which actions can be initiated in association with an item switcher. The switching manager generally includes a switcher detector 302, a control identifier 304, and a switcher presenter 306.

It should be understood that any number of components may be employed in the switching manager 300 within the scope of embodiments of the present invention. Other components or modules not shown may also be included within the switching manager 300. The switching manager 300 may operate in connection with an operating system running on a user device, such as a desktop computer, a mobile computer, or the like. Alternatively or additionally, at least some of the functionality described herein can operate separate from an operating system but function in accordance with an operating system. Although the switching manager 300 is generally described herein as being integrated at a user device, the functionality described herein may be performed remote from a user device. In this regard, the switching manager 300 may include components or modules arranged in a distributed environment that collectively provide the functionality of the switching manager 300 described herein.

The switcher detector 302 may be configured for, among other things, receiving an indication to switch, activate, or transition to a switcher view or an item switcher. The item switcher may be enabled to facilitate switching views of items (e.g., windows) and/or initiating an action in association with an item(s) via the switcher view. An item switcher or switcher view refers to a GUI, view, or portion of a display that facilitates switching or transitioning between items. To this end, a switcher view generally includes one or more item representations. In some cases, the item representations presented in an item switcher represent active items, that is, items that are currently running. In other cases, the item representations may include representations of inactive items, that is, items that are not currently running. In some cases, inactive may refer to an item that is not running at all. In other cases, inactive may refer to an item that is running in the background but does not have focus. By providing multiple item representations (e.g., representations of active windows) within a switcher view, a user can simultaneously view multiple potential items to which to switch and/or perform an action and thereby efficiently select the particular item of interest.

An item switcher can be presented in any number of formats. In some embodiments, an item switcher may be configured to generally occupy an entire display. In other embodiments, an item switcher may be configured to occupy only a portion of a display. For instance, an item switcher may be provided as a task bar, or portion thereof.

In operation, the switcher detector 302 detects an indication to view an item switcher. The item switcher may be enabled or activated from a non-switcher view by, for instance, a user selection, a user input, a gesture, or the like. A non-switcher view may be any view of a display that is not a switcher view. For instance, the non-switcher view may be a desktop of a computing device, a window displayed on a computing device, and the like. As can be appreciated, in some implementations, a switcher view and a non-switcher view can be concurrently presented. For example, a non-switcher view, such as a desktop environment, may be presented on the display screen concurrently with a switcher view presented via a taskbar. Activating a switcher view may be performed via any number of user interactions. For instance, a user may select, hover, or otherwise indicate an icon representing an item switcher, an area of a display screen designated to transition to an item switcher, or the like.

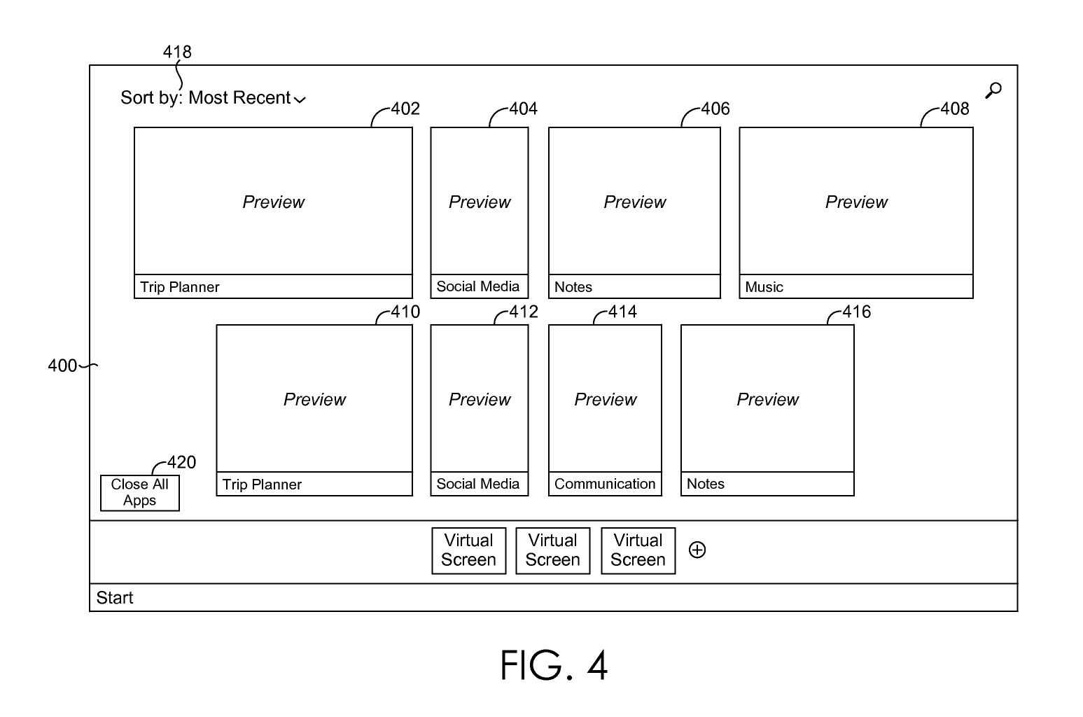

By way of example, and with reference to FIG. 4, an exemplary item switcher 400 is presented. As illustrated, the item switcher 400 includes a plurality of item representations including item representations 402, 404, 406, 408, 410, 412, 414, and 416. The presented item representations provided in this example are in the form of thumbnail images, but can take on other forms, such as icons. Each of the item representations represent a window associated with an application. Item representations 402 and 410 are associated with a trip planning application. Item representations 404 and 412 are associated with a social media application. Item representations 406 and 416 are associated with a note capturing application. Item representation 414 is associated with a communications application, and item representation 408 is associated with a music application. As the item representations in FIG. 4 represent windows, multiple item representations can be associated with a same application. For example, the item representations 402 and 410 can be associated with the same trip planning application or different trip planning applications. Similarly, the item representations 404 and 412 can be associated with the same social media application or different social media applications, and item representations 406 and 416 can be associated with the same or different note capturing applications.

The control identifier 304 is configured to identify a control(s) to overlay or integrate with an item representation(s). Generally, a control refers to a user interface object that is associated with an action. In this regard, an action is initiated in association with an item (e.g., window or application) when a control is selected. A control can be of any form including, for instance, an icon, a symbol, text, or the like. By way of example only, a control represents or symbolizes an action such that a user can readily recognize an action that will be performed in accordance with selection of the corresponding control. As can be appreciated, a control can be generated by an operating system or application, for instance, in accordance with developer preferences. That is, an operating system developer might generate a set of standard controls for use in connection with item representations. An application developer might alternatively or additionally select a particular control for use with the specific application, modify a standard control for use with the specific application, or generate and provide a customized control for use with the specific application. In such cases that an application developer designates a control, a user interface may be provided to the application developer to allow the developer to select, modify, generate, or submit a desired control or set of controls to associate with a specific application.

An action generally refers to any action that can be employed by a computer in association with an item. In some cases, an action may be a window-specific action. In this manner, as controls can be window-specific, different and separate actions on separate windows of the same application are enabled. For example, assume that two different trip planning window representations associated with an application (e.g., one representing each account logged on) are presented. In such a case, separate actions can be applied to the windows using separate controls. In other cases, an action may be application specific.

Exemplary actions may include, for instance, adjusting audio; muting audio; enabling or disabling a WiFi connection; enabling or disabling a Bluetooth connection; enabling or disabling location services; closing an item; sharing an item, or content associated therewith; controlling audio and/or video; enabling submission of a reply, comment, or other text; launching an application; a combination thereof, or the like.

A control or set of controls to associate with an item representation can be identified in any number of manners, some of which are described herein. Generally, the control identifier 304 can identify, select, or determine a control(s) to overlay on or integrate with an item representation. The control identifier 304 may utilize item attributes to select a control for association with an item representation. An item attribute refers to an attribute or data that describes or indicates a property, characteristic, performance, or ability associated with a particular item (e.g., window). By way of example only, an item attribute might be a name of the application, a name of the window, a last time a window was used, how often an application is used (e.g., cumulative history), an indication of whether the window is producing audio output, an indication of whether the window uses a WiFi connection, an indication of whether the window uses a Bluetooth connection, an indication of whether the window uses location services, an indication of whether the window is currently downloading an object, an indication of an extent or level of battery consumed by the item, an indication of whether the window requires user attention, an extent or level of memory or resources used or needed by the item, an indication of a virtual desktop being used in connection with the item, or the like.

As can be appreciated, an item attribute can be defined or designated by an operating system, an application, an operating system developer, an application developer, or the like. In some embodiments, the operating system or an application can be configured to automatically identify one or more attributes associated with item. In such embodiments, the operating system or application can analyze an item (e.g., window, or application associated therewith), and detect any number of attributes associated therewith.

In some cases, an item attribute can be a live or current attribute. As such, an item attribute can be detected in real time or near real time to reflect a current or recent state or configuration of the item. For example, at a first instance when audio is being output in association with an item, an audio attribute may be indicated as active. At a second instance when audio is not being output in association with the item, the audio attribute may be modified to reflect the more current property of the item, that is, inactive. The operating system or application may be configured to determine such attributes at any time, such as, upon expiration of a time duration, upon a change detected in association with the item, upon receiving or detecting an indication to view an item switcher, or the like. By way of example, upon receiving an indication to view an item switcher, the operating system may analyze the items (e.g., windows) to determine applicable attributes for each of the items, or a portion of the items.

Alternatively or additionally to an operating system or application determining item attributes, item attributes may be designated by an individual, such as an operating system developer, an application developer, or a user of a computing device. That is, a developer or user might specify an attribute for an item in accordance with preferences thereof. For example, an application developer might specify that any window associated with a particular application consumes a low-level of battery or includes audio capabilities.

An item attribute(s) identified or designated for a particular item can be associated therewith so that the item attribute(s) can be used to determine a control for an item representation. By way of example only, upon determining that a particular window is actively producing audio, an item attribute indicating audio can be captured in association with the window so that an audio control can be selected to overlay the representation of the window. An association between an item and one or more item attributes can be captured in any way. In one implementation, an item, or item representation, can be tagged or otherwise associated with any identified attributes. For example each window, or window representation, might be tagged with a set of metadata indicating each attribute associated with the window.

In operation, the control identifier 304 references, identifies, or accesses one or more item attributes associated with an item representation or item and, based on the attributes, selects a control or set of controls to associate with the item representation. In initiating identification of a control to apply to an item representation, an item attribute(s) associated with the item can be referenced. To this end, one or more item attributes associated with an item can be referenced, for instance, from a storage device.

Upon referencing an attribute(s) associated with an item or item representation, a control to overlay or integrate with a particular item representation can be determined. In embodiments, such a control can be selected or determined based on a set of one or more rules. A rule(s) can specify when to provide a particular control. In this regard, a particular rule or set of rules to apply in association with an item can be compared to a set of attributes associated with the item for use in determining a control to display.

As can be appreciated, a rule(s) can be associated with a particular application associated with a window, a particular item attribute, a set of specific windows, all active windows, all applications, etc. For instance, a rule may be specific to all windows or only to windows with a specific property or attribute. Examples of rules may include restricting a number of controls associated with an item at a particular instance, providing an audio control when audio is actively being produced in association with an item, providing an audio control when audio is capable of being produced in association with an item, providing a WiFi connection control when WiFi is actively being used or capable of being used, providing a location services control when location services us actively being used or capable or being used, etc.

In some cases, a rule is automatically generated, for example, via an operating system. That is, the operating system might automatically determine a rule or set of rules to employ to determine which, if any, controls to present in association with an item representation. The operating system might make such a determination based on functionalities being performed, number of active items, etc. Additionally or alternatively, a rule or set of rules might be defined by a developer, such as an operating system or application developer, or a user. An operating system developer might provide, for instance, a general set of rules that should be analyzed in connection with all items, rules that should be analyzed during various time frames or events, rules that should be analyzed in association with a particular item, item type (e.g., social media, note capturing, etc.), or set of items, or the like. An application developer might provide a set of rules specific to the application. For example, an application developer might specify a rule that when a window representation corresponding with a particular application (e.g., as indicated by an item attribute) is presented within a switcher view, a specific control should be presented in association therewith.

Determining a control(s) to present in association with an item representation can be made at any time and should not be limited herein. For example, such a determination may be made upon expiration of a time duration, upon a change detected in association with the item, upon receiving or detecting an indication to view an item switcher, or the like. By way of example, upon receiving an indication to view an item switcher, the operating system may analyze the item attributes for each of the items, or a portion of the items, and select a control(s) to present in association with the corresponding item representation.

The switcher presenter 306 is configured to present an item switcher, or a portion thereof. In this regard, the switcher presenter 306 can present the item representations and corresponding controls. The switcher presenter 306 can present a control in any manner associated with an item representation. In some embodiments, the switcher presenter 306 overlays a control over a corresponding item representation or near a corresponding item representation. In other embodiments, the switcher presenter 306 integrates a control with the corresponding item representation. As previously described, an item switcher can be presented in any location including the entirety of the display screen or a portion of the display screen.

In various implementations, the switcher presenter 306 can present additional or alternative features that can be used to apply or initiate actions via the item switcher. One of such features is a filter or set of filters. A filter can be used to filter the item representations presented in the switcher view. In this regard, the set of window representations in the switcher can be narrowed down to a particular subset matching a particular filter criteria. Such filtering can be triggered based on user input. User-triggered filtered mechanisms may include, for instance, a search box to filter any text-based criteria, a drop-down menu, a checkbox, a radio button to filter any discrete criteria, a slider or number box to filter by continuous criteria, a button or switch to filter by binary data, or the like. Any of such filters may be presented within or in association with the item switcher such that a user can select to filter the item representations. As such, the switcher presenter 306, or other component, can be configured to receive and/or detect a filter to apply and filter the item representations accordingly.

By way of example, and with reference to FIG. 4, filter 418 can be selected via a drop-down menu to filter the item representations presented within the switcher view 400. Any number or type of filters may be available for user selection or input. Various exemplary filter types include, for instance, most recent items, items associated with audio, items associated with location services, items associated with an application, items using a WiFi connection, items using a Bluetooth connection, items using an extent of battery, items associated with a specific virtual screen (filters may be applied per virtual desktop or across virtual desktops), or the like.

In accordance with receiving an indication to filter the item representations, any number of actions can occur in association with filtering. In one example, the item representations associated with items that do not meet that criteria are omitted or temporarily hidden from the switcher. For instance, assume that a user utilizes a drop-down filter to filter windows currently “using location services.” Such a filter enables the user to identify only the windows that are running and are currently using location services. In this example, the filter results in the temporary hiding of the windows that do not meet this criteria leaving only the windows that are currently using GPS location services.

In another example, the item representations associated with windows that do meet that criteria may be omitted or temporarily hidden from the switcher. In yet another example, item representations that meet or do not meet a particular criteria can be indicated as such, for instance, via highlighting, emphasizing, or otherwise denoting such item representations. Alternatively or additionally, in some embodiments, controls may be identified and applied to such filtered representations. In some cases, the items that do not meet the filter criteria may remain within the item switcher, but will not incorporate any controls that may be applicable.

Another feature that might be used to apply or initiate actions via the item switcher is a multi-item control. A multi-item control refers to a control that is not specific to a particular item, but can apply to various item or item representations. In this regard, a multi-item control can be specific to a certain set of items with certain properties or all items. A multi-item control can be presented in any number of forms including, for instance, a drop-down menu, a checkbox, a radio button, a button or switch, or the like. Any of such multi-item controls may be presented within or in association with the item switcher such that a user can select to initiate an action in connection with multiple items. As such, the switcher presenter 306, or other component, can be configured to receive and/or detect a selection of a multi-item control and initiate a corresponding action in association with a set of items.

By way of example, and with reference to FIG. 4, a multi-item control 420 can be selected via a drop-down menu to initiate an action in association with multiple item representations presented within the switcher view 400. Any number or type of multi-item controls may be available for user selection or input. Various exemplary multi-item controls include, for instance, close applications, mute audio, adjust audio, disable/enable WiFi, disable/enable Bluetooth connection, disable/enable location services, etc.

In operation, when a multi-item control is selected, the corresponding action is applied or initiated with respect to multiple items. The specific items to which to apply the action may be designated in any manner. As one example, the specific items to which to apply an action may be designated by selection of the corresponding item representations. As another example, the specific items to which to apply an action may be designated in accordance with filtering the item representations. In this regard, a filter feature may be applied to present only item representations (or otherwise highlight) associated with a particular attribute or characteristic, as previously described. Upon filtering the item representations and selecting a particular multi-item control, the action associated with the multi-item control can be applied to the presented item representations. For instance, upon filtering to a particular subset of window representations, a specific action, such as closing the windows, can be applied to all the running windows.

By way of example, and with reference to FIGS. 5-7, FIGS. 5-7 illustrate various features that can be presented in association with an item switcher to initiate and/or apply actions in association therewith. Initially, with reference to FIG. 5, FIG. 5 illustrates an item switcher 500 having multiple item representations. As illustrated, the item representations presented via the item switcher 500 are filtered in association with a “most recent” filter 530. Upon transitioning to the item switcher 500, various controls can be presented in association with the item representations, as appropriate. For example, assume that audio is identified as being produced in association with a window represented by window representation 508 and a window represented by window representation 514. In such a case, audio control 522 and 524 can be presented in association with the item representation 508 and 514, respectively. Assume the user desires to mute the audio associated with the window represented by window representation 514. In such a case, the user can select the audio control 524 to initiate muting of the audio.

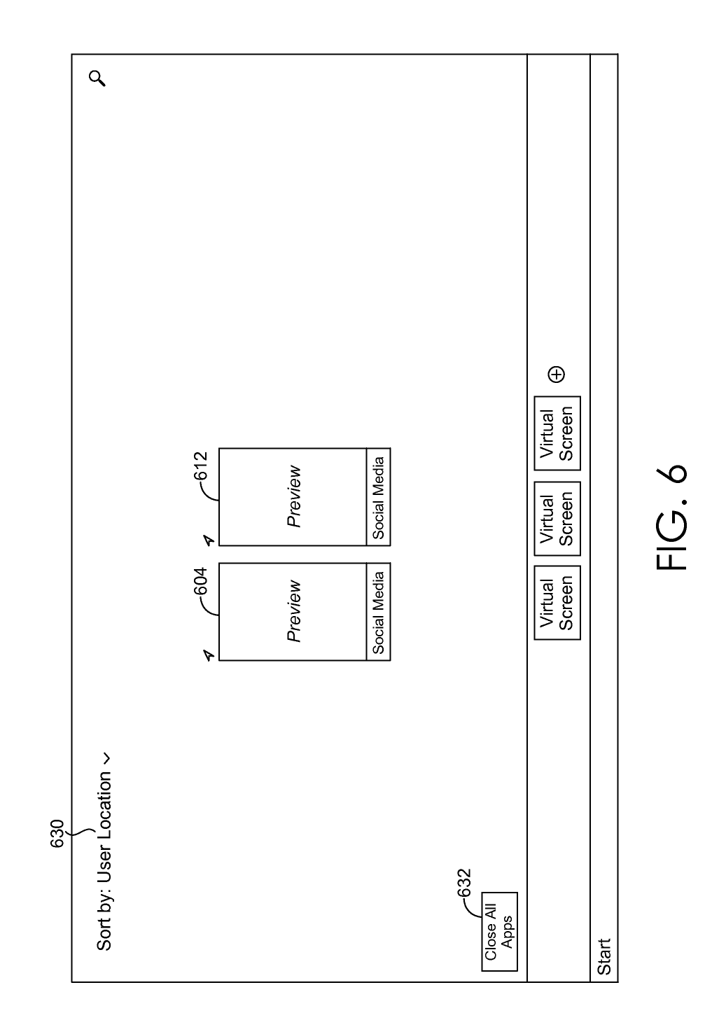

Assume now that a user wishes to initiate an action in association with windows that are currently utilizing location services. In such a case, and with reference to FIG. 6, a user may select a “user location” 630 filter to temporarily remove window representations that are not associated with location services. In this regard, item representations 604 and 612 associated with location services remain presented via the item switcher. As can be appreciated, the user can initiate an action associated with such item representations individually or globally via a multi-item control. Accordingly, the user may select the multi-item control 632 to close the items (e.g., windows) associated with location services. Other multi-item controls may also be selected to apply to each of the items.

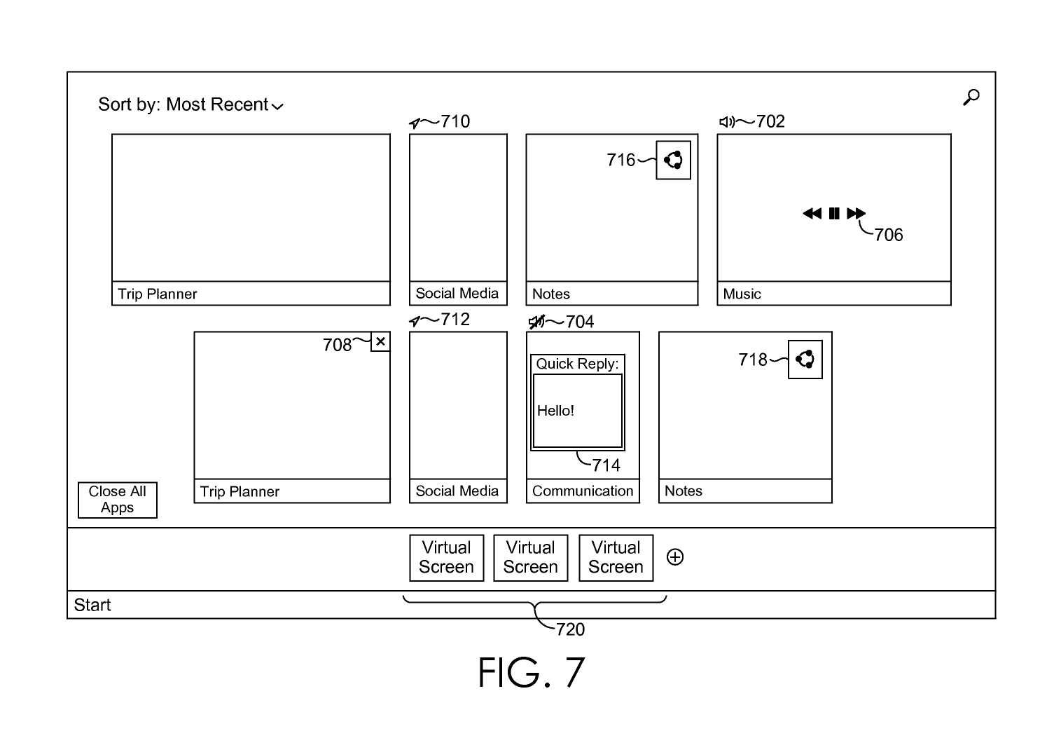

FIG. 7 illustrates various controls that can be overlaid or integrated with item representations. As illustrated, audio controls 702 and 704 can be presented in association with representations of items that produce or are capable of producing audio output. Selection of such audio controls 702 and 704 can enable adjustment of the audio, such as muting the audio, corresponding with the item. Media navigation control 706 can be presented in association with an item that can be controlled, such as an application producing audio and/or video media. Selection of such the media control 706, or portion thereof, can be used to control the play of the media via the item. Closing control 708 can be presented in association with various items. Selection of the closing control 708 results in closing the item associated with the item representation. Location services control 710 and 712 can be presented in association with items using or capable of using location services. Selection of such location services control 710 or 712 may result in enabling or disabling utilization of location services. Text control 714 can be presented in association with items that accept text input, such as a social media application. A user may input text into the text control 714 to provide a reply or content. Share controls 716 and 718 can be presented in association with items having content that can be shared, for instance, with other application users. In this manner, the share controls 716 and 718 can be selected to initiate sharing of information. Further, as illustrated in FIG. 7, a user may select a virtual screen via virtual screen controls 720 to view an item switcher associated with the selected virtual screen. In this regard, as items may be associated with a particular virtual screen, corresponding item representations may be presented in an item switcher associated with the particular virtual screen. These displayed controls and actions described in accordance therewith are only exemplary in nature and are not intended to limit the scope of embodiments of the present invention.

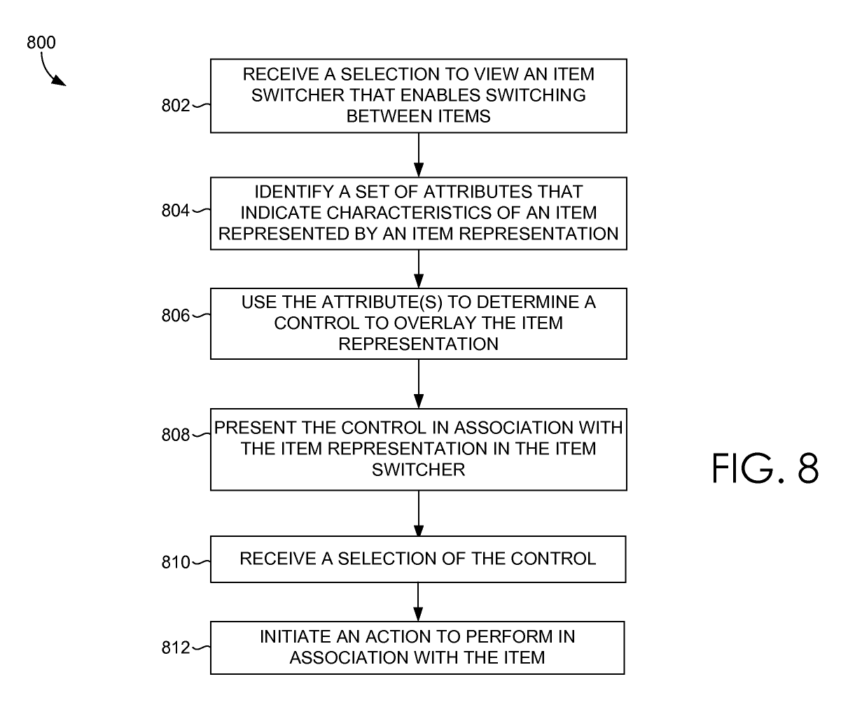

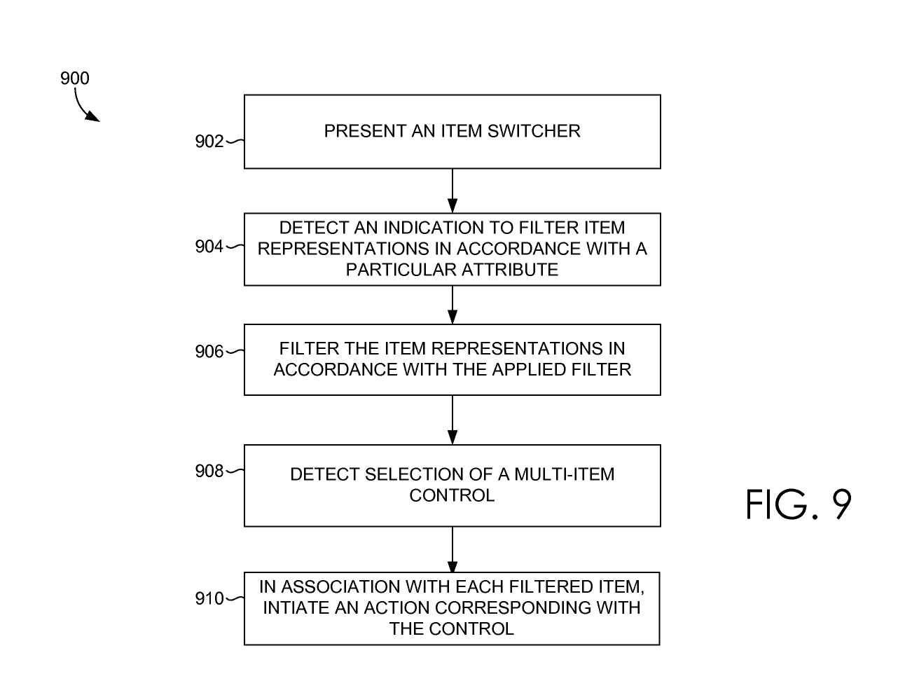

Turning now to FIGS. 8-9, flow diagrams are illustrated that facilitate initiating actions via an item switcher. Method 800 of FIG. 8 and method 900 of FIG. may be performed, at least in part, by an operating system of a computing device. Method 800 and method 900 are presented as examples, and are not intended to limit the scope of embodiments of the present invention.

With reference to FIG. 8, a flow diagram is shown that illustrates one exemplary method 800 for initiating an action via an item switcher. Initially, as indicated at block 802, a selection to view an item switcher that enables switching between items is received. Such an indication may be received in any manner. For instance, a user may select an item switch icon or specified location on the display screen while in a non-switching view to trigger activation of an item switcher. At block 804, a set of attributes that indicate characteristics of an item represented by an item representation is identified. Attributes may be designated by an application. For example, an application developer may specify attributes to be associated with an application, or windows associated therewith. Alternatively or additionally, attributes may be designated or identified by an operating system. For instance, an operating system may analyze an application, or window associated therewith, and determine characteristics thereof.

At block 806, the attribute(s) is used to determine a control to overlay the item representation. In some embodiments, the attribute(s) may be analyzed in light of one or more rules that indicate a control to utilize. Thereafter, the control is presented in association with the item representation in the item switcher, as indicated at block 808. Subsequently, at block 810, a selection of the control is received. For instance, a user might hover over and/or select the control. An action to perform in association with the item is initiated upon selection of the corresponding control. This is indicated at block 812.

Turning now to FIG. 9, FIG. 9 is a flow diagram that illustrates another exemplary method 900 for initiating an action via an item switcher. At block 902, an item switcher is presented. Such an item switcher includes a plurality of item representations that represent various items, such as active windows. The presented item switcher also includes a filter portion and a multi-item control portion. At block 904, an indication to filter the item representations in accordance with a particular attribute is detected. In this regard, a user selection to filter the item representations based on, for example, a characteristic of the corresponding items may be detected or received. The item representations are filtered in accordance with the applied filter, as indicated at block 906. At block 908, a selection of a multi-item control is detected. Subsequently, at block 910, in association with each item represented by the filtered item representations, an action corresponding with the multi-item control is initiated. In this manner, upon a user-selection of a multi-item control, a corresponding action can be applied to multiple items, such as those represented by item representations within an item switcher following application of a filter.

To recapitulate, embodiments of the present invention are directed to facilitating initiation of actions via an item switcher. In some cases, one or more controls can be presented in associated with an item representation via an item switcher to enable a user to select such a control thereby initiating the corresponding action. Additional or alternative actions can also be performed via the item switcher, such as, for instance, filtering item representations or applying actions in connection with multiple items.

Accordingly, in one aspect, one or more computer-readable media having computer-executable instructions embodied thereon that, when executed, perform a method for initiating actions via a switcher view are provided. The method includes determining a control to present in association with a window representation that represents a window associated with an application. In a switcher view including a plurality of window representations, the control is presented in association with the window representation. In response to a selection of the control, an action corresponding with the control is initiated while maintaining the switcher view, wherein the action comprises a functionality performed in association with the application.

In another aspect, a computer system embodied on one or more computer storage-media having computer-executable instructions provided thereon for initiating actions via a switcher view is provided. The computer system includes an input component to receive a user input indicating to view an input switcher that presents representations of active windows. The computer system also includes a processing component to determine one or more controls to present in association with one or more window representations, wherein the one or more controls indicate a corresponding action to perform in association with the active window. The computer system further includes a presentation component to render the input switcher, the input switcher including the one or more window representations and corresponding controls that are selectable to initiate the corresponding action.

In yet another aspect, a computerized method for initiating actions via a switcher view is provided. The method includes receiving a selection to view a window switcher that enables switching between windows. The window switcher presents a plurality of window representations, with each window representation being non-interactive and representing a corresponding window. A set of attributes are identified that indicate characteristics of a first window represented by a first window representation. The set of attributes are utilized to determine a control to overlay the first window representation, and the control is overlaid in association with the first window representation in the window switcher. Such a control, if selected, enables an action to be initiated in association with the first window.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well-adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for initiating actions via a switcher view, the method comprising:
determining a control to present in association with a window representation that represents a window associated with an application;
in a switcher view including a plurality of window representations, presenting the control in association with the window representation; and
in response to a selection of the control, initiating an action corresponding with the control while maintaining the switcher view, wherein the action comprises a functionality performed in association with the window.

2. The media of claim 1, wherein the determination of the control to present is specified by an operating system.

3. The media of claim 1, wherein one or more attributes characterizing the window are used to determine a control to present.

4. The media of claim 3, wherein the one or more attributes are dynamically identified based on a current state of one or more configurations of the application or the window.

5. The media of claim 1, wherein the determination of the control to present is based on a preference of an application developer.

6. The media of claim 1, wherein the action is performed in association with the application without navigating to the window.

7. The media of claim 1, wherein the plurality of window representations represent active windows.

8. The media of claim 7, wherein the active windows comprise windows actively running via an operating system.

9. A computer system embodied on one or more computer storage-media having computer-executable instructions provided thereon for initiating actions via a switcher view, the system comprising:
an input component to receive a user input indicating to view an input switcher that presents representations of active windows;
a processing component to determine one or more controls to present in association with one or more window representations, wherein each of the one or more controls indicate an action to perform in association with the corresponding active window; and
a presentation component to render the input switcher, the input switcher including the one or more window representations and associated controls that are selectable to initiate the corresponding action.

10. The computer system of claim 9, wherein the user input is received when a non-switcher view is presented.

11. The computer system of claim 9, wherein the processing component further determines a set of attributes for each of the one or more window representations.

12. The computer system of claim 11, wherein at least a portion of the set of attributes are determined in real-time.

13. The computer system of claim 9, wherein the input switcher further comprises a filter portion that provides one or more filters available to apply in association with the one or more window representations.

14. The computer system of claim 9, wherein the input switcher further comprises a multi-item control portion that provides one or more multi-item controls available to apply to a plurality of active windows.

15. A computerized method for initiating actions via a switcher view, the method comprising:
receiving a selection to view a window switcher that enables switching between windows, the window switcher presenting a plurality of window representations, each window representation representing a corresponding window;
identifying a set of attributes that indicate characteristics of a first window represented by a first window representation;
using the set of attributes to determine a control to overlay the first window representation; and
overlaying the control in association with the first window representation in the window switcher, wherein the control, if selected, enables an action to be initiated in association with the first window.

16. The computerized method of claim 15, wherein at least a portion of the set of attributes are dynamically determined via the operating system based on real-time characteristics of the first window.

17. The computerized method of claim 15, wherein the plurality of window representations represent active windows.

18. The computerized method of claim 15, wherein the set of attributes are compared to one or more rules to determine the control to overlay the first window representation.

19. The computerized method of claim 15 further comprising rendering a multi-item control to enable an action to be performed in association with multiple windows upon selection of the multi-item control.

20. The computerized method of claim 15 further comprising rendering a filter to enable the window representations presented in the window switcher to be filtered.
